(19) United States
(12) Patent Application Publication
(10) Pub. No.: US 2025/0139254 A1
(43) Pub. Date: May 1, 2025

(54) DISASSEMBLING AUTHORIZED CODE SERVICES TO DETERMINE VALID PARAMETERS AND PARAMETER VALUES TO GENERATE INPUT SET

(71) Applicant: International Business Machines Corporation, Armonk, NY (US)

(72) Inventors: Michael Page KASPER, Wappingers Falls, NY (US); Bryan CHILDS, Poughkeepisie, NY (US); Diane Marie STAMBONI, Poughkeepsie, NY (US); Joshua David STEEN, Fishkill, NY (US); Andrew C. M. HICKS, Highland, NY (US)

(21) Appl. No.: 18/499,297

(22) Filed: Nov. 1, 2023

(51) Int. Cl. G06F 21/57

(52) U.S. Cl. CPC G06F 21/577; G06F 2221/033

(57) ABSTRACT

Embodiments of the present disclosure provide methods, systems, and computer program products for generating an input set for implementing security vulnerability testing of a software programs for authorized services. Object code of the software program is received, and the object code is disassembled to identify instructions. The instructions are analyzed to determine where specific input registers are referenced. Usage of values stored in the specific input registers when the software program is executed is determined for at least one of comparing against the values stored in the specific input registers for test or conditional branch logic, copying the values stored in the specific input registers, or referencing storage at a location defined by the values in the specific input registers. One or more arrays describing values of one or more possible or valid parameters are generated based on the usage to provide the input set.

### BACKGROUND

The present invention relates to providing security within computing environments, and in particular, to generating an input set for security vulnerability testing of software programs or authorized services.

In a computer system, a kernel is a core component of an operating system that handles various tasks, such as running processes, managing devices, handling interrupts, and the like. Some tasks are performed by the kernel responsive to a system call from a process, while other tasks are performed responsive to system conditions and system management logic. The kernel has access to a memory system of a computer and can control provisioning of the memory system to user processes and operating system processes. The kernel can support virtual addressing through grouping portions of memory into pages to make larger segments or frames of memory available and appear contiguous even if the underlying physical addresses of the memory are noncontiguous.

Authorized services, also known as kernel services or authorized programs, can allow unauthorized programs to perform authorized functions. Authorized services are expected to verify input from an unauthorized program in order to maintain the integrity of the computer system. However, unauthorized programs can call authorized programs in unexpected ways, potentially causing an authorized program to bypass integrity checks of the computer system and violate system confidentiality, integrity, or availability.

### SUMMARY

Embodiments of the present disclosure are directed to methods, systems, and computer program products for generating an input set for implementing security vulnerability testing of authorized services.

A disclosed computer implemented non-limiting method comprises analyzing the instruction data of a software program to determine where specific input registers are referenced. The method also comprises determining usage of values stored in the specific input registers when the software program is executed, where the usage comprises at least one of (i) comparing against the values stored in the specific input registers for test or conditional branch logic, (ii) copying the values stored in the specific input registers, or (iii) referencing storage at a location defined by the values in the specific input registers. The method also comprises generating one or more arrays describing values of one or more possible or valid parameters based on the usage to provide an input set for security vulnerability testing of the software program.

According to one embodiment of the present disclosure, a system is provided. The system includes one or more computer processors, and a memory containing a program which when executed by the one or more computer processors performs an operation. The operation comprises analyzing the instruction data of a software program to determine where specific input registers are referenced. The operation also comprises determining usage of values stored in the specific input registers when the software program is executed, where the usage comprises at least one of (i) comparing against the values stored in the specific input registers for test or conditional branch logic, (ii) copying the values stored in the specific input registers, or (iii) referencing storage at a location defined by the values in the specific input registers. The operation also comprises generating one or more arrays describing values of one or more possible or valid parameters based on the usage to provide an input set for security vulnerability testing of the software program.

According to one embodiment of the present disclosure, a computer program product is provided. The computer program product includes a computer-readable storage medium having computer-readable program code embodied therewith, the computer-readable program code executable by one or more computer processors to perform an operation. The operation comprises analyzing the instruction data of a software program to determine where specific input registers are referenced. The operation also comprises determining usage of values stored in the specific input registers when the software program is executed, where the usage comprises at least one of (i) comparing against the values stored in the specific input registers for test or conditional branch logic, (ii) copying the values stored in the specific input registers, or (iii) referencing storage at a location defined by the values in the specific input registers. The operation also comprises generating one or more arrays describing values of one or more possible or valid parameters based on the usage to provide an input set for security vulnerability testing of the software program.

### BRIEF DESCRIPTION OF THE DRAWINGS

FIG. 1 is a block diagram of an example computer environment for use in conjunction with one or more disclosed embodiments for generating an input set for security vulnerability testing of software programs for authorized services;

FIG. 2 is a block diagram of an example system for generating an input set for security vulnerability testing of software programs for authorized services of one or more disclosed embodiments;

FIG. 3 is a flow chart illustrating example operations of a method for dynamically generating an input set for security vulnerability testing of a software program of one or more disclosed embodiments;

FIGS. 4A and 4B together provide a flow chart illustrating example operations of a method for analyzing code to generate an input set for security vulnerability testing of authorized services of one or more disclosed embodiments; and

FIG. 5 is a flow chart illustrating a method for dynamically generating an input set for security vulnerability testing of a software program of one or more disclosed embodiments.

To facilitate understanding, identical reference numerals have been used, where possible, to designate identical elements that are common to the figures. It is contemplated that elements disclosed in one embodiment may be beneficially used in other embodiments without specific recitation.

### DETAILED DESCRIPTION

Embodiments of the present disclosure provide methods, systems, and computer program products for generating an input set for implementing security vulnerability testing of authorized services. Disclosed embodiments analyze instructions of a software program to determine where specific input registers are referenced and determine the usage of values stored in the specific input registers when the software program is executed. Disclosed embodiments effectively and efficiently generate one or more arrays describing values of one or more possible or valid parameters to provide the input set.

According to an aspect of disclosed embodiments, there is provided a non-limiting computer implemented method. The method comprises analyzing the instruction data of a software program to determine where specific input registers are referenced. The method also comprises determining usage of values stored in the specific input registers when the software program is executed, where the usage comprises at least one of (i) comparing against the values stored in the specific input registers for test or conditional branch logic, (ii) copying the values stored in the specific input registers, or (iii) referencing storage at a location defined by the values in the specific input registers. The method also comprises generating one or more arrays describing values of one or more possible or valid parameters based on the usage to provide an input set for security vulnerability testing of the software program. The method enables effectively and efficiently generating the input set with values of possible or valid parameters without requiring source code or dynamic testing to analyze the software program. The method enables effective and efficient generation of the input set, which enables enhanced overall processing time for security vulnerability testing of the software program, minimizing the number of tests needed. The method generates an input set with meaningful input values that are effectively and efficiently learned from determining usage of values stored in the specific input registers when the software program is executed, and generating one or more arrays describing values of one or more possible or valid parameters by understanding instructions data of the software program. The method enables generating the input set without requiring an Application Program Interface (API) of the software program.

According to an aspect of disclosed embodiments, there is provided a system comprising one or more computer processors, and a memory containing a program which when executed by the one or more computer processors performs an operation. The operation comprises analyzing the instruction data of a software program to determine where specific input registers are referenced. The operation also comprises determining usage of values stored in the specific input registers when the software program is executed, where the usage comprises at least one of (i) comparing against the values stored in the specific input registers for test or conditional branch logic, (ii) copying the values stored in the specific input registers, or (iii) referencing storage at a location defined by the values in the specific input registers. The operation also comprises generating one or more arrays describing values of one or more possible or valid parameters based on the usage to provide an input set for security vulnerability testing of the software program. The system enables effectively and efficiently generating the input set with values of possible or valid parameters without requiring source code or dynamic testing to analyze the software program. The system enables effective and efficient generation of the input set, which enables enhanced overall processing time for security vulnerability testing of the software program, minimizing the number of tests needed. The system generates an input set with meaningful input values that are effectively and efficiently learned from determining usage of values stored in the specific input registers when the software program is executed, and generating one or more arrays describing values of one or more possible or valid parameters by understanding instructions data of the software program. The system enables generating the input set without requiring an Application Program Interface (API) of the software program.

According to an aspect of disclosed embodiments, there is provided a computer program product. The computer program product comprising a computer-readable storage medium having computer-readable program code embodied therewith, the computer-readable program code executable by one or more computer processors to perform an operation. The operation comprises analyzing the instruction data of a software program to determine where specific input registers are referenced. The operation also comprises determining usage of values stored in the specific input registers when the software program is executed, where the usage comprises at least one of (i) comparing against the values stored in the specific input registers for test or conditional branch logic, (ii) copying the values stored in the specific input registers, or (iii) referencing storage at a location defined by the values in the specific input registers. The operation also comprises generating one or more arrays describing values of one or more possible or valid parameters based on the usage to provide an input set for security vulnerability testing of the software program. The computer program product enables effectively and efficiently generating the input set with values of possible or valid parameters without requiring source code or dynamic testing to analyze the software program. The computer program product enables effective and efficient generation of the input set, which enables enhanced overall processing time for security vulnerability testing of the software program, minimizing the number of tests needed. The computer program product generates an input set with meaningful input values that are effectively and efficiently learned from determining usage of values stored in the specific input registers when the software program is executed, and generating one or more arrays describing values of one or more possible or valid parameters by understanding instructions data of the software program. The computer program product enables generating the input set without requiring an Application Program Interface (API) of the software program.

An embodiment of the present disclosure further comprises, before analyzing the instructions receiving object code, by a disassembler, of the software program, and disassembling the object code of the software program to identify the instructions. The embodiment enables efficiently generating the input set with values of possible or valid parameters by obtaining a readable executable software program file of the software program to pass object code to a disassembler for disassembly. The embodiment enables generating the input set without requiring source code or dynamic testing to analyze the software program.

Additionally, an embodiment of the present disclosure where receiving, by the disassembler, the object code of the software program further comprises identifying the software program from one or more sets of software programs of interest. The embodiment enables efficiently generating the input set by identifying the software program from various software programs of interest.

Additionally, an embodiment of the present disclosure where analyzing the instruction data of the software program to determine where specific input registers are referenced further comprises checking a parameter list based on register values. Enhanced overall processing time for generating the input set may be enabled by efficiently determining specific input registers from the parameter list. Enhanced overall processing time may be provided by using the parameter list to efficiently identify specific input registers used for one or more possible or valid parameters to provide the input set.

Additionally, an embodiment of the present disclosure where determining the usage of values stored in the specific input registers when the software program is executed further comprises determining the values of one or more possible or valid parameters compared against the values stored in the specific input registers for the branch on condition or the test logic when the software program is executed. Enhanced overall processing time may be enabled by efficiently determining the values of possible or valid parameters to provide the input set for security vulnerability testing of the software program, and enabling additional testing paths.

Additionally, an embodiment of the present disclosure where determining usage of values stored in the specific input registers when the software program is executed further comprises determining the values of one or more possible or valid parameters of any reassignments, or local variables where the values stored in the specific input registers are saved when the software program is executed. Enhanced overall processing time for generating the input set may be enabled by efficiently determining the values of possible or valid parameters to provide the input set for security vulnerability testing of the software program, and may enable additional testing paths.

Additionally, an embodiment of the present disclosure where determining usage of values stored in the specific input registers when the software program is executed further comprises determining the values of one or more possible or valid parameters retrieved from referencing storage at the location defined by the values stored in the specific input registers when the software program is executed. Enhanced overall processing time for generating the input set may be enabled by efficiently determining the values of possible or valid parameters to provide the input set for security vulnerability testing of the software program, and may enable additional testing paths.

Additionally, an embodiment of the present disclosure where generating one or more arrays describing values of one or more possible or valid parameters further comprises generating a notification of the input set for security vulnerability testing of the software program. The embodiment enables efficiently using the input set for security vulnerability testing of the software program.

Additionally, an embodiment of the present disclosure where generating one or more arrays describing values of one or more possible or valid parameters further comprises generating a parameter list of the values of the one or more possible or valid parameters based on comparing against the values stored in the specific input registers for the branch on condition or the test logic. Enhanced overall processing time for generating the input set with possible or valid parameters may be enabled by generating the parameter list, and may enable an enhanced input set.

Additionally, an embodiment of the present disclosure where generating one or more arrays describing values of one or more possible or valid parameters further comprises generating a parameter list of the values of the one or more possible or valid parameters based on copying the values stored in the specific input registers. Enhanced overall processing time for generating the input set with possible or valid parameters may be enabled by generating the parameter list, and may enable an enhanced input set.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

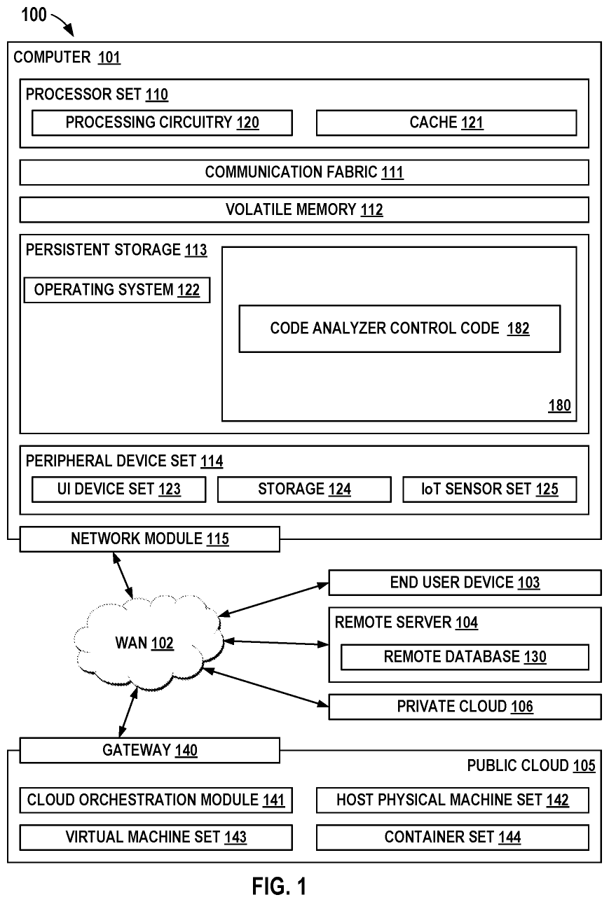

Referring to FIG. 1, a computing environment 100 contains an example of an environment for the execution of at least some of the computer code involved in performing the inventive methods, such as a Code Analyzer Control Code 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Disclosed embodiments provide methods, systems, and computer program products for generating an input set for implementing security vulnerability testing of software programs of authorized services. Source code may not be available for older unsupported or custom application programs and for proprietary vendor programs, while such software programs can pose a risk to the security of a system and need to be tested. Disclosed embodiments enable testing security vulnerability, without access to any source code, by analyzing instructions of a software program to determine where specific input registers are referenced and determining usage of values stored in the specific input registers when the software program is executed. Disclosed embodiments enable identifying meaningful inputs for use in dynamic security vulnerability testing, which can drive more code paths and can find more security vulnerabilities while also minimizing the number of tests needed. Determining an input set of meaningful inputs of disclosed embodiments allows for determination of values of parameters that can result in differential results, as opposed to sampling with random data to guess possible value ranges, which is much less efficient.

Disclosed embodiments disassemble object code of a software program and analyzing instructions of a software program to determine where specific input registers are referenced and determine values of parameters meaningful for testing security of the software program or software module. An authorized service includes for example a Supervisor Call Instruction (SVC) or Program Call (PC) or AC(1) program on an operating system, such as a Z operating system (zOS) or a kernel call or such as a setuid program on an example Linux operating system. When authorized services are called, parameters are passed into specific registers used as parameter registers. In accordance with a disclosed embodiment, starting at the first instruction in the program, or entry point, and disassembling the code can identify where the specific registers are referenced, and determine usage of values stored in the specific input registers when the software program is executed. The usage includes at least one of comparing against the values stored in the specific input registers for test or conditional branch logic, copying the values stored in the specific input registers, or referencing storage at a location defined by the values in the specific input registers. Disclosed embodiments can determine usage of values stored in the specific input registers to understand what the software program is doing, while disassembling the software program using a disclosed automated process. In accordance with a disclosed embodiment, a comparison of the value in an unchanged input register that is followed by a conditional branch instruction that either branches or does not based on the result of that comparison identifies a reference to parameters that is significant to security vulnerability testing of the software program or authorized service.

Disclosed embodiments compare the value in the register itself without offsets or control block chains to follow, and the nature of the comparison is significant. Disclosed embodiments, by understanding the categories of comparison instructions and their formats, can determine a value being compared against the values stored in the specific input registers, such as a constant value in the instruction or a constant value found elsewhere in the software program. Disclosed embodiments can record the compared value and the nature of the comparison to determine that the specific register is not being used as an input address, for example depending on the instruction, but is used for comparisons and determine possible values that are greater, less than, or equal to the value of comparison. When further testing that service later, the disclosed embodiments can provide such values that are greater than, less then, or equal to the value of comparison in order to drive additional code paths. Disclosed embodiments can determine instructions that compare a value at some offset from the address pointed to by an unchanged input register, and record the offset from that address to build test parameters.

Disclosed embodiments can provide a list of instructions that copy or save a register value of a specific register, when copying the value in the register, either into storage or into another register. Disclosed embodiments can provide, similar to learning a list of comparison instructions, a list of instructions that copy or save the value of a specific register, and if the instruction being examined takes that action against an unchanged input register, can record where the input value is saved to know for future reference that a comparison against the copy is the same as a comparison against the original. Disclosed embodiments also can look for instructions that make comparisons against copies of the input values, in addition to instructions followed by conditional branch instructions that make comparisons against input register values, followed by conditional branches based on the comparisons.

Disclosed embodiments can keep track of relative addresses or locations defined by the values stored in the specific input registers referencing storage, for example for retrieving one or more data values from storage, when the register value is used as an address for retrieving data values from storage. Disclosed embodiments can build a tree or parameter list of linked addresses based on offsets from addresses, all determined by the instructions. One disclosed example can include a load into a register, followed by a load based on that result into another register, followed by a comparison made against an address pointed to by the result of that load, and followed by a conditional branch instruction. Disclosed embodiments can, by disassembling instructions, determine how to build a two level parameter list where an input register value points to an address that points to another address that points to a value that could be greater than, less than, or equal to the value of comparison in the conditional branch comparison instruction. Disclosed embodiments can provide the input set with pointers at offsets and values to meet the various conditions for comparisons for testing of the software program. For example, the pointers at offsets and values can drive the testing to discover more security vulnerabilities in a given software program, without knowing an Application Program Interface (API) in advance because possible and valid parameters are determined by object code disassembly of the software program.

In later dynamic testing, the generated input set of disclosed embodiments can enable more effectively detecting security vulnerabilities, for example with additional testing paths. The dynamic testing includes various techniques, such as program check analysis from attempting to cause buffer overflows, or simply passing invalid data or inaccessible addresses to the software program. The program check analysis includes examining any resulting program checks that occur, for example to determine if the authorized service is reading or writing to storage where it should not or branching to caller provided locations in an authorized state.

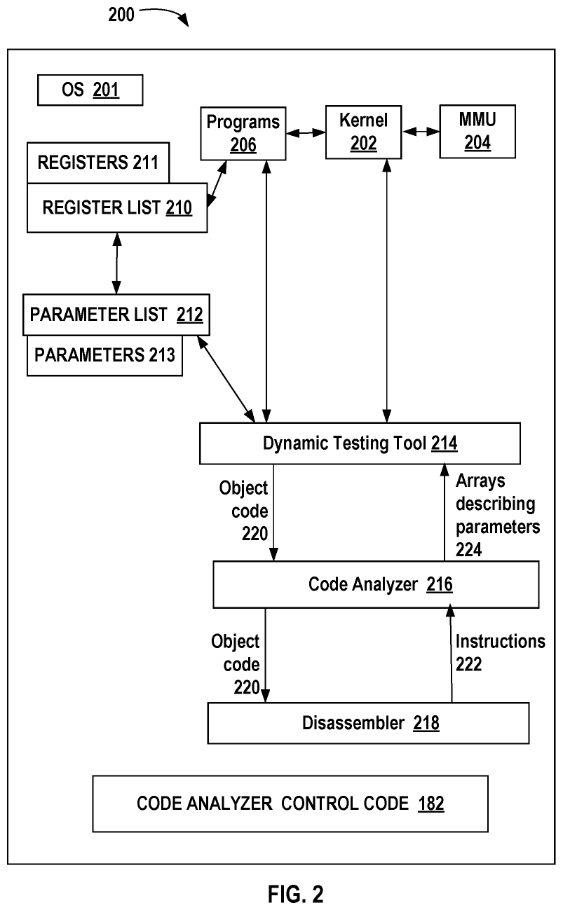

FIG. 2 illustrates an example system 200 of disclosed embodiments. System 200 can be used in conjunction with the computer 101 and cloud environment of the computing environment 100 of FIG. 1 for implementing inventive methods of disclosed embodiments. System 200 includes an operating system 201, (e.g., a Z operating system or Linux operating system) such as operating system 122 of FIG. 1. System 200 includes a kernel 202 of the operating system, and a memory management unit (MMU) 204, for example to support mapping of virtual page addresses to actual (e.g., physical or effective) page addresses in the memory that is subdivided into a plurality of address spaces, where each address space can have a different access permission. System 200 includes one or more sets of software programs 206; for example, the software programs 206 can include various software programs or authorized services, such as a Program Call (PC), a Supervisor Call (SVC), or AC(1) program, a kernel call, or a Setuid program, or other software programs. System 200 includes a register list 210 with one or more specific registers 211, which point to a parameter list 212 of parameter data including of parameters 213, such as, parameter data used as input to a given software program 206 or authorized service. In a disclosed embodiment, when a software program 206, such as an SVC or PC or AC(1) program on z/OS is called, parameters 213 are passed into specific registers 211 used as parameter registers.

System 200 includes a dynamic testing tool 214, a code analyzer 216, and a dissembler 218 in accordance with disclosed embodiments. In a disclosed embodiment, the dynamic testing tool 214 couples object code 220 of a given software program 206 to the code analyzer 216 and the dissembler 218. The dissembler 218 disassembles the object code of the given software program 206, and provides instructions 222 to the code analyzer 216. The code analyzer 216 receives and analyzes the instructions 222 from the dissembler 218, for example while the object code of a given software program 206 is being disassembled.

In disclosed embodiments, system 200 can start at entry point in a given software program 206 (e.g., the first instruction in the software program), and disassemble an object code or binary executables of the software program, using the dissembler 218, to provide the instructions 222 to the code analyzer 216. The code analyzer 216 analyzes the instructions 222 to determine where specific registers 211 are referenced. The code analyzer 216 determines usage of values stored in the specific input registers 211 when the software program is executed. The usage includes at least one of comparing against the values stored in the specific input registers 211 for test or conditional branch logic, copying the values stored in the specific input registers 211, or referencing storage at a location defined by the values in the specific input registers 211. In a disclosed embodiment, for example, when a comparison of the value of an unchanged input register 211 is followed by a conditional branch instruction that either branches or does not based on the result of that comparison, system 200 has found a reference to parameters 213 that is significant to testing the authorized service. Arrays describing values of one or more possible or valid parameters 213 based on the usage are generated to provide an input set of disclosed embodiments. In a disclosed embodiment, for example, the dynamic testing tool 214 receives the input set for subsequent security vulnerability testing of authorized services, or for use in real time testing of a given software program 206.

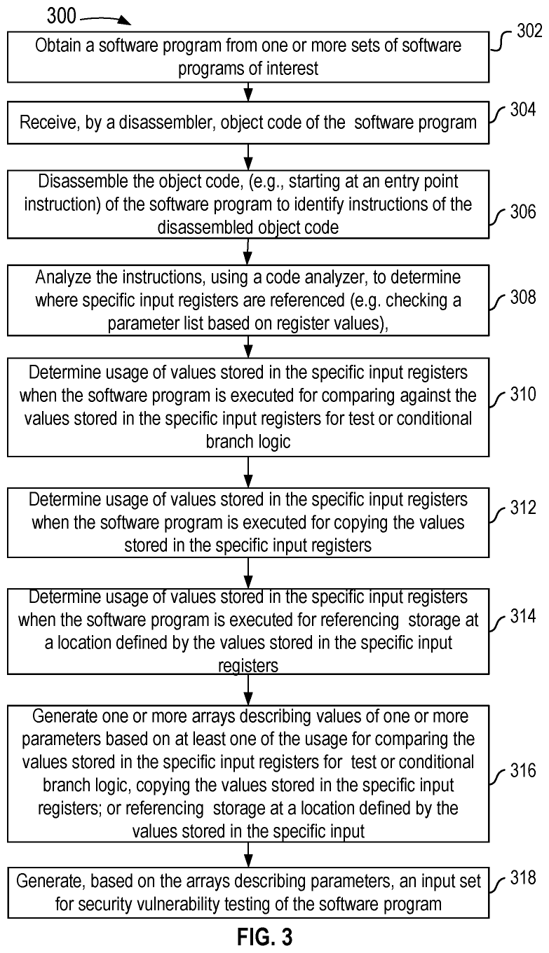

FIG. 3 illustrates example operations of a method 300 for dynamically generating an input set for security vulnerability testing of software programs or authorized services of one or more disclosed embodiments. For example, method 300 is implemented by the system 200 in conjunction with the computer 101 of FIG. 1 and the Code Analyzer Control Code 182.

At block 302, system 200 obtains a software program from one or more sets of software programs of interest, such as software programs 206 shown in FIG. 2. For example, software programs 206 of interest include kernel services such as a Supervisor Call Instruction (SVC) or Program Call (PC) or AC(1) program on an operating system or a kernel call or setuid program on another an operating system. At block 304, system 200 receives object code, by the disassembler 218, of the software program. In a disclosed embodiment, system 200 can locate and obtain a readable executable software program file of the software program 206, to pass the object code to the disassembler 218 for disassembly. At block 306, system 200 disassembles the object code of the software program 206, using the disassembler 218, to identify instructions of the disassembled object code. In a disclosed embodiment, system 200 starts at entry point (e.g., the first instruction) in the software program, and disassembles the object code of the software program 206 and can couple the instructions in real time to a code analyzer, such as code analyzer 216.

At block 308, system 200 analyzes the instructions, using the code analyzer 216, to determine where specific registers are referenced. In a disclosed embodiment, system 200 includes a register list 210 of one or more specific registers 211 used as parameter registers, and a parameter list 212 for parameter data of possible or valid parameters 213. In a disclosed embodiment, system 200 can find where the specific registers are referenced, for example by checking the parameter list 212 based on register values.

In a disclosed embodiment, for example, when disassembling the executable file code, system 200 checks for usage of values stored in the specific input registers 211. At block 310, system 200 determines usage of values stored in the specific input registers, when the software program is executed, for comparing against the values stored in the specific input registers 211 for test or conditional branch logic. In a disclosed embodiment, system 200 determines values of possible or valid parameters 213, based on comparing a value against a value stored in the register 211 for the test or conditional branch logic. In a disclosed embodiment, for example, when system 200 is comparing the value in the specific register 211 itself, there are no offsets or control block chains to follow, while the nature of the comparison is significant for testing with the input set. By identifying the categories of comparison instructions and their formats, system 200 can determine values for the test or conditional branch logic compared with the register value stored in the specific input registers 211, such as a constant value in the instructions or a constant value found elsewhere in the software program 206.

In a disclosed embodiment, system 200 identifies input value and the nature of the comparison, for example when determined that the register 211 is not being used as an input address, (e.g., depending on which bits were being compared) and instead the value stored in the specific register 211 is used for comparisons. In one embodiment, system 200 can determine meaningful values of possible or valid parameters, for example, of values that are greater than, less than, or equal to a stored register value of the comparisons. In a disclosed embodiment for future testing, system 200 provides possible values that are greater than, less than, or equal to the stored register values of one or more given comparisons in order to drive additional code paths during testing of the software program. In a disclosed embodiment, system 200 also processes instructions that compare a value of possible or valid parameters at some offset from the address pointed to by an unchanged value of specific input registers 211. System 200 can apply the same or similar logic to record the offset from the address to build additional test parameters, and parameter lists.

At block 312, system 200 determines usage of the values stored in the specific input registers 211, during execution of the software program, for copying the values stored in the specific input registers 211. In a disclosed embodiment, for example, when system 200 is processing or executing an instruction that is copying the value stored in a given specific input register 211, either into storage or into another register, system 200 can provide a list of instructions that copy or save the values of the specific input register 211 (e.g., similar to providing a list of comparison instructions). In addition to looking for instructions that make comparisons against input register values, followed by conditional branches, in one embodiment system 200 also looks for instructions that make comparisons against copies of the input values, followed by conditional branches. When the instruction being examined copies the value stored in a given specific input register, system 200 can record or save information for the copy including where the input value is saved for future use to reference a comparison against the copy as the same as a comparison against the original value.

At block 314, system 200 determines usage of the values stored in the specific input registers 211 during execution of the software for referencing storage at a location defined by the values stored in the specific input registers. In a disclosed embodiment, system 200 can identifies values of one or more possible or valid parameters 213 based on instructions to reference storage at the location defined by the values stored in the specific input registers 211. In a disclosed embodiment, for example, when system 200 processes an instruction where the stored value of a specific input register 211 is used as an address for retrieving another data value from storage, system 200 can record the relative addresses that are loaded based on the input register address determined by using an unchanged value stored in a given specific input register 211 to define the storage location. In a disclosed embodiment, for example, system 200 can build a tree of linked addresses based on offsets from addresses, all determined by the instruction data of the disassembled object code.

At block 316, system 200 generates one or more arrays describing values of one or more possible or valid parameters based on at least one of the usage for comparing against the values stored in the specific input registers for test or conditional branch logic, copying the values stored in the specific input registers, or referencing storage at a location defined by the values in the specific input registers, such as determined at blocks 312, 312, and 314. For example in one embodiment, system 200 can identify a load into a register, followed by a load based on that result into another register, followed by a comparison made against an address pointed to by the result of that load, and followed by a conditional branch. For example, by disassembling the above four instructions, system 200 can determine how to build a two level parameter list where a value stored in an input register points to an address that points to another address that points to another value that could be greater than, less than, or equal to the value stored in specific input register of a comparison in a given comparison instruction.

At block 318, system 200 generates, based on the arrays describing parameters, an input set for security vulnerability testing of the software program. In a disclosed embodiment, for example, system 200 can generate the input set for security vulnerability testing without source code of, or dynamic testing the software program and without knowing the program Application Programming Interface (API), because system 200 determines values of possible and valid parameters by the object code disassembly. When testing the software program, system 200 can use the input set to provide value pointers at the offsets and values of the various conditions for comparisons, such as of the above examples, to discover more security vulnerabilities in the software program, for example with additional testing paths.

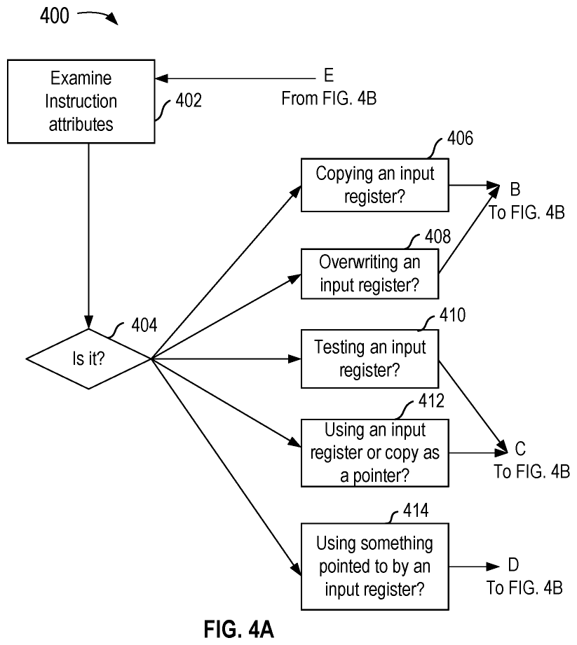

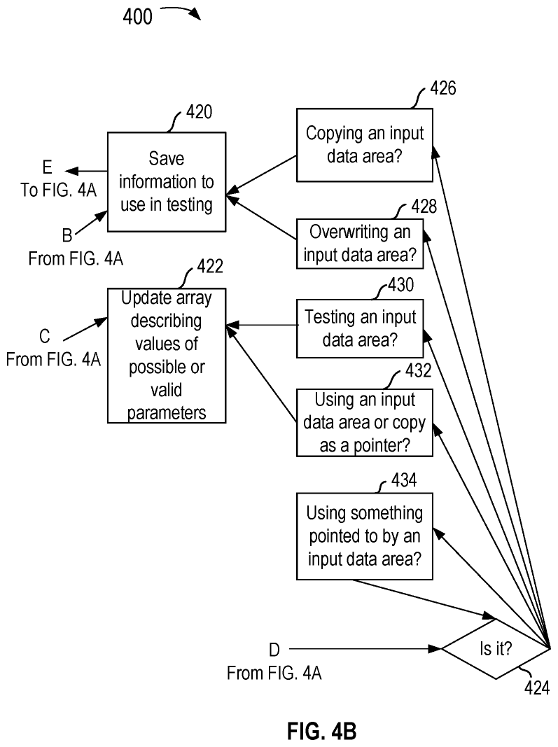

FIGS. 4A and 4B together illustrate example operations of a method 400 for analyzing instructions to generate an input set for security vulnerability testing of authorized services of one or more disclosed embodiment. For example, method 400 can be implemented by the system 200 with the code analyzer 212 in conjunction with the computer 101 of FIG. 1 and the Code Analyzer Control Code 182.

Operations begin at block 402 in FIG. 4A, code analyzer 212 examines instruction attributes or instruction data. At decision block 404, code analyzer 212 analyzes or checks the instruction data to determine the meaning or function of the disassembled instructions, including usage of the values stored in the specific input registers 211 (e.g., for the specific input registers 211 referenced by instructions as identified at block 308). At block 406, code analyzer 212 determines if the instruction is copying an input register, (e.g., copying the values stored in the specific input registers such as determined at block 312 in FIG. 3). If so, operations continue following entry point B at block 420 in FIG. 4B.

Referring also to FIG. 4B, at block 420, code analyzer 212 saves the instruction information of the copying the input register at block 406 for later use in a dynamic testing process for testing security vulnerability. In FIG. 4A at block 408, code analyzer 212 determines if the instruction is overwriting an input register. If so, operations continue again following entry point B at block 420 in FIG. 4B to save the instruction information of the overwriting the input register at block 408.

In FIG. 4A at block 410, code analyzer 212 determines if the instruction is testing an input register (e.g., testing values stored in the specific input registers 211). If so, operations continue following entry point C at block 422 in FIG. 4B. In FIG. 4B at block 422, code analyzer 212 updates an array of one or more arrays describing values of possible and valid parameters with the testing instruction information (e.g., such as the one or more arrays describing values of possible and valid parameters generated at block 316 of FIG. 3).

In FIG. 4A at block 412, code analyzer 212 determines if the instruction is using an input register or copy of the input register as a pointer. If so, operations continue following entry point C at block 422 in FIG. 4B to update an array of the one or more arrays describing values of possible and valid parameters (e.g., generated at block 316 in FIG. 3) with the pointer instruction information. In FIG. 4A at block 414, code analyzer 212 determines if the instruction is using something pointed to by an input register. If so, operations continue following entry point D at decision block 424 in FIG. 4B.

Turning again to FIG. 4B at decision block 424, code analyzer 212 analyzes or checks the instruction data to determine the meaning or function being pointed to by the input register (e.g., using an input data area pointed to by the input register, such as the referencing storage at a location defined by the values stored in the specific input registers determined at block 314 in FIG. 3). At block 426, code analyzer 212 determines if the instruction is copying an input data area, and if so, saves the instruction copying information of the input data area being copied at block 420 for later use in testing security vulnerability. At block 428, code analyzer 212 determines if the instruction is overwriting an input data area, and if so at block 420, code analyzer 212 saves the instruction information of the input data area being overwritten. At block 430, code analyzer 212 determines if the instruction is testing an input data area. When determined the instruction is testing the input data area, code analyzer 212 updates an array of one or more arrays describing values of possible or valid parameters with the input data area instruction information at block 422. At block 432, code analyzer 212 determines if the instruction is using an input data area or copy of the input data area as a pointer. When determined the instruction is using the input data area or copy as a pointer, at block 422 code analyzer 212 updates the array of one or more arrays describing values of possible or valid parameters with the pointer input data area or copy instruction information. At block 434, code analyzer 212 determines if the instruction is using something pointed to by an input data area. When determined the instruction is using something pointed to by the input data area, operations return to block 424, where code analyzer 212 analyzes or checks the instruction data to determine the meaning or function being pointed to by the input data area and operations continue as described above.

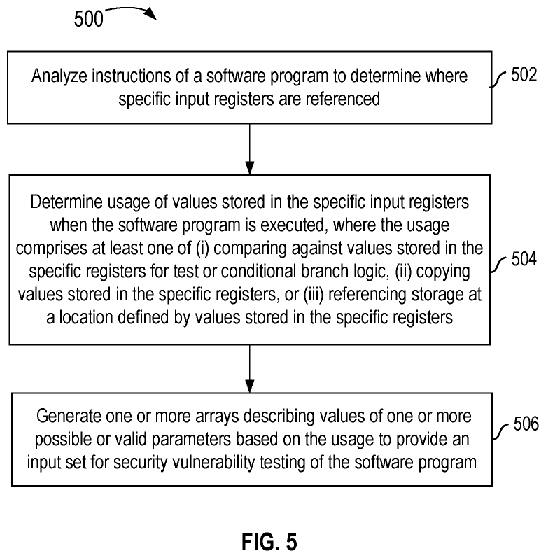

FIG. 5 illustrates a method 500 for dynamically generating an input set for security vulnerability testing of authorized services of one or more disclosed embodiments. Method 500 illustrates features and operations of methods 300 and 400 of disclosed embodiments. The method 500 can be implemented by the system 200 in conjunction with the computer 101 of FIG. 1 with the Code Analyzer Control Code 182.

At block 502, system 200 analyzes instructions of a software program to determine where specific registers are referenced. For example, system 200 includes a register list 210 of one or more specific registers 211 used as parameter registers, and a parameter list 212 for parameter data of possible or valid parameters 213. For example, in a disclosed embodiment, the parameter data pointed to by instructions referencing the specific register 211, is used as input to the software program. In a disclosed embodiment, when the software program 206, such as an SVC or PC or AC(1) program on z/OS is called, parameters 213 are passed into specific registers 211.

At block 504, system 200 determines usage of values stored in the specific registers when the software program is executing, where the usage comprises at least one of i) comparing against the values stored in the specific input registers for test or conditional branch logic, (ii) copying the values stored in the specific input registers, or (iii) referencing storage at a location defined by the values in the specific input registers. In a disclosed embodiment, system 200 determines values and addresses, for the test or conditional branch logic based on determining the usage at block 504. In a disclosed embodiment, system 200 determines the values and addresses compared with the values stored in the specific input registers 211, such as a constant value in the instructions or a constant value found elsewhere in the software program 206. In a disclosed embodiment, system 200 saves instruction information of copying the values stored in the specific input registers, and for referencing storage at a location defined by the values in the specific input registers based on the usage at block 504.

At block 506, system 200 generates one or more arrays describing values of one or more possible or valid parameters based on the usage to provide an input set for security vulnerability testing of the software program. For example, in a disclosed embodiment, generating the one or more arrays describing values of one or more possible or valid parameters based on the usage includes determining the values of one or more possible or valid parameters compared against the values stored in the specific input registers for the branch on condition or the test logic. In a disclosed embodiment, generating the one or more arrays includes saving the instruction information both for copying the values stored in the specific input registers, and for referencing storage at a location defined by the values in the specific input registers.

For example, in a disclosed embodiment, generating the one or more arrays at block 506 can include generating one or more parameter lists for instructions comparing against the values stored in the specific input registers for test or conditional branch logic, for copying or saving values stored in the specific input registers, such as copying or saving the values into storage or into another register, and referencing storage at a location defined by the values in the specific input registers. The input set of disclosed embodiment, enables enhanced testing, for example by providing a specific bit pattern, number, or keyword, or specific values being tested against, which can enable testing additional paths of the program where some type of a secret phrase or secret value can present a roadblock for testing tools. For example, in a disclosed embodiment, the input set enables testing more paths to find security vulnerabilities of a software program or authorized service, such as the software program allows reading or writing to storage where it should not, or branching to caller provided locations in an authorized state where it should not.

While the foregoing is directed to embodiments of the present invention, other and further embodiments of the invention may be devised without departing from the basic scope thereof, and the scope thereof is determined by the claims that follow.

What is claimed is:

1. A method comprising:
analyzing instructions of a software program to determine where specific input registers are referenced;
determining usage of values stored in the specific input registers when the software program is executed, wherein the usage comprises at least one of (i) comparing against the values stored in the specific input registers for test or conditional branch logic, (ii) copying the values stored in the specific input registers, or (iii) referencing storage at a location defined by the values stored in the specific input registers; and
generating one or more arrays describing values of one or more possible or valid parameters based on the usage to provide an input set for security vulnerability testing of the software program.

2. The method of claim 1, further comprising, before analyzing the instructions:
receiving, by a disassembler, object code of the software program; and
disassembling the object code of the software program to identify instructions.

3. The method of claim 2, wherein receiving, by a disassembler, object code of a software program further comprises identifying the software program from one or more sets of software programs of interest.

4. The method of claim 1, wherein analyzing the instructions of the software program to determine where specific input registers are referenced further comprises checking a parameter list based on register values.

5. The method of claim 1, wherein determining usage of values stored in the specific input registers when the software program is executed further comprises determining the values of one or more possible or valid parameters compared against the values stored in the specific input registers for the branch on condition or the test logic when the software program is executed.

6. The method of claim 1, wherein determining usage of values stored in the specific input registers when the software program is executed further comprises determining the values of one or more possible or valid parameters of any reassignments, or local variables where the values stored in the specific input registers are saved when the software program is executed.

7. The method of claim 1, wherein determining usage of values stored in the specific input registers when the software program is executed further comprises determining the values of one or more possible or valid parameters retrieved from referencing storage at the location defined by the values stored in the specific input registers when the software program is executed.

8. The method of claim 1, wherein generating, based on the one or more arrays describing parameters, the input set further comprises generating a notification of the input set for security vulnerability testing of the software program.

9. The method of claim 1, wherein generating one or more arrays describing values of one or more possible or valid parameters further comprises generating a parameter list of the values of the one or more possible or valid parameters based on comparing against the values stored in the specific input registers for the branch on condition or the test logic.

10. The method of claim 1, wherein generating one or more arrays describing values of one or more possible or valid parameters further comprises generating a parameter list of the values of the one or more possible or valid parameters based on copying the values stored in the specific input registers.

11. A system, comprising: one or more computer processors; and a memory containing a program which when executed by the one or more computer processors performs an operation, the operation comprising:
analyzing instructions of a software program to determine where specific input registers are referenced;
determining usage of values stored in the specific input registers when the software program is executed, wherein the usage comprises at least one of (i) comparing against the values stored in the specific input registers for test or conditional branch logic, (ii) copying the values stored in the specific input registers, or (iii) referencing storage at a location defined by the values stored in the specific input registers; and
generating one or more arrays describing values of one or more possible or valid parameters based on the usage to provide an input set for security vulnerability testing of the software program.

12. The system of claim 11, further comprising, before analyzing the instructions:
receiving, by a disassembler, object code of the software program; and
disassembling the object code of the software program to identify the instructions.

13. The system of claim 11, wherein analyzing the instructions of the software program to determine where specific input registers are referenced further comprises checking a parameter list based on register values.

14. The system of claim 11, wherein determining usage of values stored in the specific input registers when the software program is executed further comprises determining the values of one or more possible or valid parameters compared against the values stored in the specific input registers for the test or conditional branch logic when the software program is executed.

15. The system of claim 11, wherein determining usage of values stored in the specific input registers when the software program is executed further comprises determining the values of one or more possible or valid parameters of any reassignments, or local variables where the values stored in the specific input registers are saved when the software program is executed.

16. A computer program product comprising a computer-readable storage medium having computer-readable program code embodied therewith, the computer-readable program code executable by one or more computer processors to perform an operation comprising:
analyzing instructions of a software program to determine where specific input registers are referenced;
determining usage of values stored in the specific input registers when the software program is executed, wherein the usage comprises at least one of (i) comparing against the values stored in the specific input registers for test or conditional branch logic, (ii) copying the values stored in the specific input registers, or (iii) referencing storage at a location defined by the values stored in the specific input registers; and
generating one or more arrays describing values of one or more possible or valid parameters based on the usage to provide an input set for security vulnerability testing of the software program.

17. The computer program product of claim 16, further comprising, before analyzing the instructions:
receiving, by a disassembler, object code of the software program; and
disassembling the object code of the software program to identify the instructions.

18. The computer program product of claim 16, wherein analyzing the instructions of the software program to determine where specific input registers are referenced further comprises checking a parameter list based on register values.

19. The computer program product of claim 16, wherein determining usage of values stored in the specific input registers when the software program is executed further comprises determining the values of one or more possible or valid parameters compared against the values stored in the specific input registers for the test or conditional branch logic when the software program is executed.

20. The computer program product of claim 16, wherein determining usage of values stored in the specific input registers when the software program is executed further comprises determining the values of one or more possible or valid parameters of any reassignments, or local variables where the values stored in the specific input registers are saved when the software program is executed.
